(19) United States
(12) Patent Application Publication
(10) Pub. No.: US 2005/0102271 A1
(43) Pub. Date: May 12, 2005

(54) Indexes with embedded data

(76) Inventor: Gavin Robertson, Arlington, TX (US)

Correspondence Address: HOWISON & ARNOTT, L.L.P, P.O. BOX 741715, DALLAS, TX, 75374-1715, US

(21) Appl. No.: 10/909,647

(22) Filed: Jul. 31, 2004

Related U.S. Application Data
(60) Provisional application No. 60/492,183, filed on Aug. 1, 2003.

(51) Int. Cl. G06F 17/30

(52) U.S. Cl. 707/2

(57) ABSTRACT

A value field index for data stored in a data source is generated by analyzing a data source schema, analyzing intended queries of the data and analyzing the data. Problematic queries are identified and token fields are designated. The value field indexes are then created using the data source schema; and the value indexes are embedded in other indexes.

### CROSS-REFERENCE TO RELATED APPLICATIONS

This application claims priority on U.S. Provisional Patent Application Ser. No. 60/492,183 (Atty. Dkt. No. OGPT-26,350), filed on Aug. 1, 2003.

### TECHNICAL FIELD OF THE INVENTION

This invention is related to the field of database management and search systems.

### BACKGROUND OF THE INVENTION

Traditionally, transactional databases systems are designed and built to execute transactions. They are typically not designed and built to support complex queries associated with data mining, business analytics or customer relationship management (CRM) among other applications. The traditional way to cope with the demands of these applications is to move the transactional data on a routine basis to an operational data store (ODS). From there, the data is moved to a data warehouse, which is used for some of the complex query application. However, others require additional data movement to data marts—smaller data warehouses—and to special data formats such as multidimensional data schemes, where online analytical processing (OLAP or ROLAP) can be performed.

These data movements attempt to solve a variety of problems. These problems include: overloaded transactional systems, poor query performance, summarization and aggregation, combining multiple data sources, data transformation, and data cleansing. The attempt to solve these problems, however, may introduce several other problems, including: static data, rather than real time data, de-normalized data schemes introduce data redundancy and referential integrity issues on update, additional system and storage costs, costly implementation time and difficulties in relating the data back to the original data sources.

Basically, data warehouses, data marts and multidimensional data schemas were introduced to overcome deficiencies in traditional database query processing. What is needed, therefore, is a database indexing system that can be accessed without reference to the way and place data is stored.

### SUMMARY OF THE INVENTION

A value field index for data stored in a data source is generated by analyzing a data source schema, analyzing intended queries of the data and analyzing the data. Problematic queries are identified and token fields are designated. The value field indexes are then created using the data source schema; and the value indexes are embedded in other indexes.

### BRIEF DESCRIPTION OF THE DRAWINGS

For a more complete understanding of the present invention and the advantages thereof, reference is now made to the following description taken in conjunction with the accompanying Drawings in which:

FIG. 1 illustrates a flow chart of a build value index process;

FIG. 2 illustrates a flow chart of a basic query;

FIG. 3 illustrates a normalized form transactional data schema;

FIG. 4 illustrates high level field indexes;

FIG. 5 illustrates multiple value indexes referring to a single table; and

FIG. 6 illustrates multiple value indexes.

### DETAILED DESCRIPTION OF THE INVENTION

Referring now to the drawings, wherein like reference numbers are used herein to designate like elements throughout the various views, embodiments of the present invention are illustrated and described, and other possible embodiments of the present invention are described. The figures are not necessarily drawn to scale, and in some instances the drawings have been exaggerated and/or simplified in places for illustrative purposes only. One of ordinary skill in the art will appreciate the many possible applications and variations of the present invention based on the following examples of possible embodiments of the present invention.

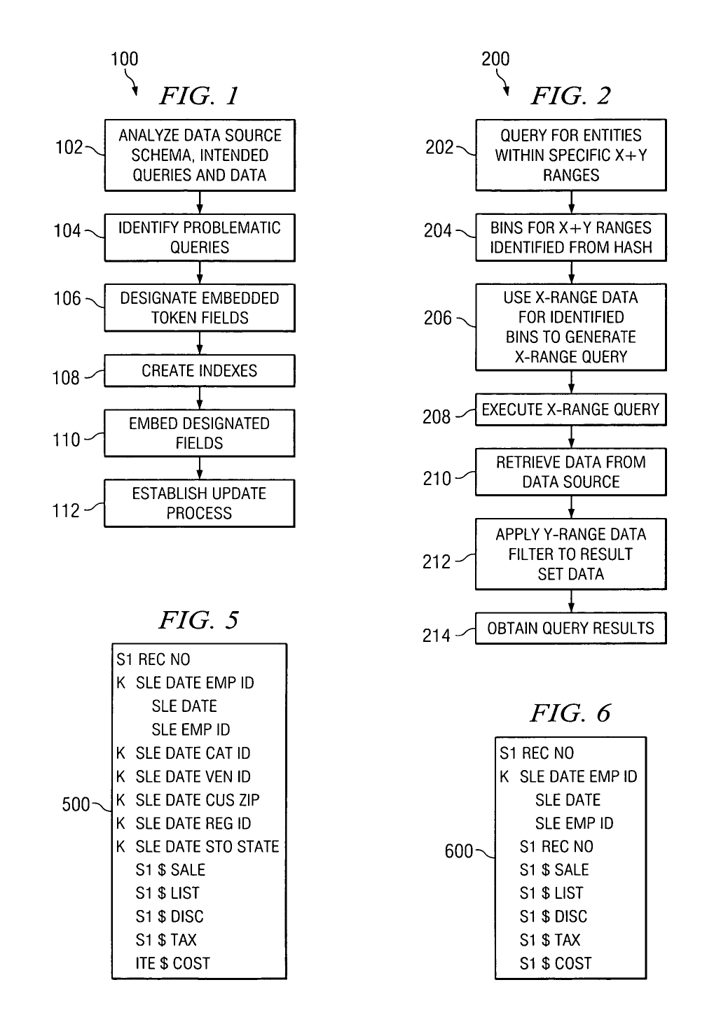

With reference to FIG. 1, a flowchart for a process that embeds data in an otherwise conventional database index is shown. This embedded data can also be indexed and thereby allow an alternative access to data in the database than conventionally allowed. In one embodiment, the embedded data may be used to de-normalize or “flatten” a highly normalized relational database. A query that would have involved a 5-way table-join on a fifth-normal transactional database can be reduced to a single table lookup. In another embodiment, the embedded data may be used to add relational capabilities to a flat-file system. Alias data may be added to the indexes in a police flat-file system.

The embedded data, or embedded indexes, can be implemented in at least three ways, depending on performance and storage considerations. One method uses a conventional index “as is,” with no optimization. The embedded data scheme is intended to complement database, and in some cases unstructured text, searches, index and query processing technologies.

The basic premise behind embedded indexes is that it does not really matter how and where data is stored. What is important is how the data is indexed and how queries are processed against these indexes.

With reference to FIG. 1, a process to build embedded indexes 100 is shown. The process 100 creates indexes that honor the original data source's data schema and format. These indexes can be created using the original data source's database technology or using an external indexing technology.

The process 100 begins at function block 102 where the data source is analyzed. The data source schema, intended queries and the data itself may be analyzed. The process continues to function block 104 where the types of queries that need to be made against these indexes are determined. Queries that could be highly problematic are identified. The process proceeds to function block 106 where fields that could be embedded as tokens in the indexes to other data that could, in turn, be indexed and used to improve query performance are designated. The process continues at function block 108 where the indexes are created. The designated fields are embedded at function block 110. The process continues to function block 112 where processes to update these embedded tokens as data is added or changed in the original data sources, in batch, incremental or real-time modes are established.

With reference to FIG. 2, a flowchart of a process to perform a spatial query 200 is shown. The process 200 performs a query of an embedded index including a large number of entities that include detailed spatial location data X and Y. Normally, two expensive range queries are used to isolate the correct X records and the correct Y records, and then the two result sets are combined in a Boolean operation. Seeking to improve query performance two steps involving embedded indexes are taken. First all records are screened and placed in high-level, predefined “bins” based on their location. Tokens representing these bins are embedded in the X and Y indexes and themselves indexed. Second, each entity's Y value is embedded as a token in the X value index, but is not in itself indexed.

An improved spatial query can thereby be executed in process 200. At function block 202, a query for entities with specific X and Y ranges is made. At function block 204, the bin or bins for the X and Y ranges are identified from a simple hash. The simple hash is the same one used to determine the bins in the first place. At function block 206, the X-range data index is used for the identified bin or bins. At function block 208, an X-range query is made. The process proceeds to function block 210 where a data result set is retrieved from the original data source. At function block 212, an Y-range data filter is applied to the result set data. At function block 214, the results that fit the original query criteria are obtained.

The process 200 confines the X-range query to a smaller subset of data in a specific bin (or bins) and avoids the need for a Y range query.

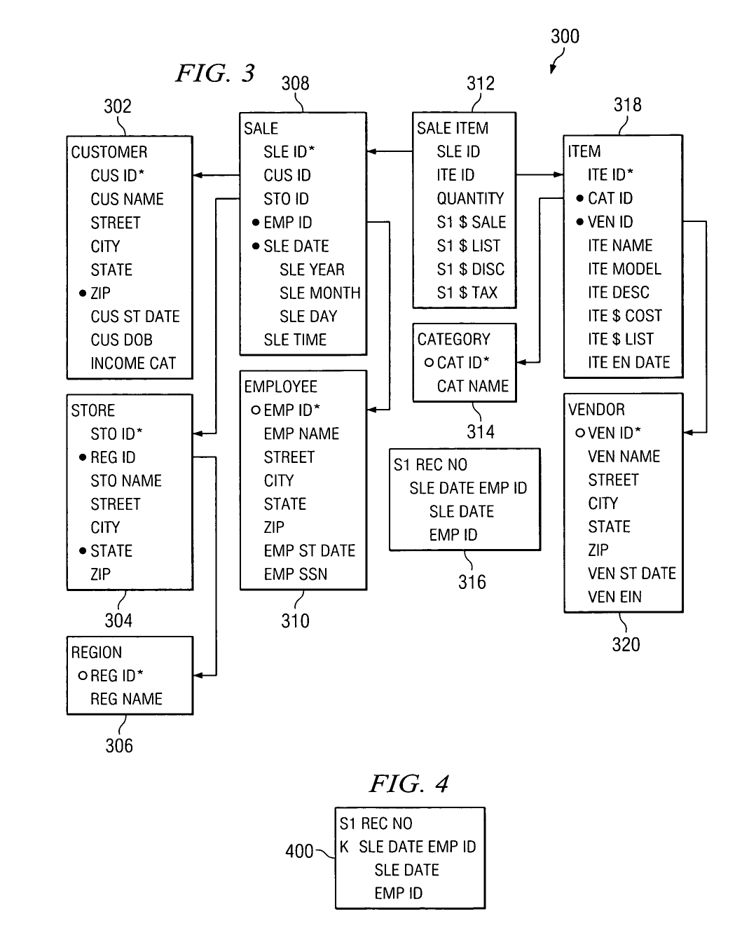

With reference to FIG. 3, a data mart view of highly normalized transactional data 300 is shown. The database includes a variety of tables including customer 302, store 304, region 306, sale 308, employee 310, sale item 312, category 314, item 318 and vendor 320. A value index 316 is shown. A transactional database consists of a highly normalized data schema. The fields are embedded as tokens in the low-level data index. The fields marked with an open bullet are primary key fields not used for the Value Index as a lower level Foreign Key field is available. The ID fields marked with an asterisk are unique primary keys. The fields marked with a closed bullet are embedded value index fields. The value indexes provide views and allow us to perform aggregations on high-level fields, such as customer zipcode, region, store state, employee, sales date, item category and item vendor. These high-level fields are embedded as tokens in the low-level data indexes for fields in the designated fields are embedded.

FIGS. 4, 5 and 6 show three levels of value index implementation. These are three levels allow higher-level data to be embedded in indexes to lower-level data. Each level increases performance, but also increases the resource requirements for storage and CPU overhead. The value indexes shown refer to S-I_RECNOs of the SALE-ITEM table. At the lowest level of available data, this is a one-to-one relationship.

With reference to FIG. 4, a first level value index 400 is shown. The high-level field index 400 may be independently maintained and link to the SALE-ITEM table through S-I_RECNO and other table values, such as ITE_$COST. These may be obtained through a single-tablejoin from SALE-ITEM table to the ITEM table, which may result in a non-sequential read of values. Similar tables could be created for SLE_DATE_CAT_ID, SLE_DATE_VEN_ID, SLE_DATE_CUS_ZIP, SLE_DATE_REG_ID and SLE_DATE_STO_STATE or any field that a user might want to see and aggregation on.

With reference to FIG. 5, a second level value index 500 is shown. The multiple value index 500 refers to a single table containing designated low-level data, such as S-I_$SALE, S-I_$LIST, S-I₁₃$DISC, S-I_$TAX and ITE_$COST, sorted by S-I_RECNO, which may result in a non-sequential read of values.

With reference to FIG. 6, a third level value index 600 is shown. A multiple value index 600 is created for each value index. Similar tables could be created for SLE_DATE_CAT_ID, SLE_DATE_VEN_ID, SLE_DATE_CUS_ZIP, SLE_DATE_REG_ID and SLE_DATE_STO_STATE or any fild that a user might want to see and aggregation on. Each multiple value index 600 contains low-level data, sorted by the value index for rapid sequential reading.

A value index 500 is essentially a virtual data warehouse. Value index 600 is a series of min-virtual data warehouses, with one for each value index.

For a normally static database or normally static part of a database, a value index can consist of a unique-node index tree with starting ROWID and record count at each node for rapid sequential read of values in a value table for the high level value index 600.

For a live database or the live part of a database, a value index field index can consist of a normal index tree with a list of ROWIDs at each node referring to a value table in a memory or cache in the second level value index 500 or directly to the first level value index 400.

Storing data source values external to a data source may be undesireable. In this case, the low level value index 400 may be preferred.

An EIQ server refers to a query server with an external index. There are many benefits to using an EIQ server. An EIQ server provides universal and uniform near real-time external indexing, query processing and integration of all structured, unstructured and semi-structured data and information in multiple databases, files, documents and email. An EIQ server connects like a database driver. An EIQ server provides single point access. EIQ servers can be used for both intra-organization and inter-organization work. The EIQ server can combine database queries and unstructured text searches. Queries can be processed virtually in the indexes, with no temporary or interim tables for table joins or range queries. EIQ servers can use data and information from one system to find data and information in another. For example, table-joins across databases can be performed, allowing heuristic data mining across databases and other data sources.

EIQ servers allow extremely simple SQL statements, because the processing occurs on the back-end. Therefore there is no need to specify data sources, although the data sources may be specified. As well, the table-joins and queries do not need to be specified to be processed. EIQ servers allow the use of standards for field names. An EIQ server can set up “superschemas” which create custom views (tables) of standard data and information fields. These can be established as relational. The EIQ server brings some structure to unstructured data and information and more structure to less-structured data such as flat file systems.

EIQ servers permit universal and uniform access to different platforms and locations, allowing the use of native drivers and access where possible. The EIQ server can be used to secure LANs, WANs, VPNs and IP networks, including the Internet, intranets and extranets. EIQ servers allow secure logins, passwords and access levels to specific agencies, data sources within agencies and fields within data sources.

EIQ servers provide the advantage of leaving source data in place in the original format. This allows using third party replication or ETL tools to update indexes from transaction logs for databases and allows the use of spiders and crawlers for other data. Only the indexes used conform to standards, allowing the data to remain unchanged. ROWIDs, primary keys and other unique identifiers are used to directly retrieve the final result-set data. Mapping tables between standard field names and actual data source field names are maintained by the data source owner. Security access is also established and maintained by the data source owner, providing the data source owner with no loss of control over the data.

EIQ servers allow users to continue to use legacy applications and data, while enabling modem application access to legacy data, as well as allowing legacy application access to modem databases. EIQ servers may be used as a transition or migration tool from legacy to modem systems. EIQ servers can virtually normalize legacy flat-file systems to a certain extent and virtually flatten modem relational databases for legacy applications.

EIQ servers permit scaling through multi-tiered access to independently maintained indexes in different agencies and organizations. This allows the use of secure SOAP and can lead to secure XML and web services. EIQ servers are able to submit queries and integrate responses from non-EIQ server data sources. This is known as a federated database technique.

EIQ servers allow extremely fast query processing. Typically, the query processing may be 10 to 100 times faster than other systems, particularly in a multi-user environment. EIQ servers allow real time updates that are immediately available for queries.

Embedded indexes allow additional data and information to be stored in the indexes, while the original data remains unaltered. This improves query performance, including faster table-joins without join-indexes. This adds value to the original data and provides connect or group data and information. Virtual data warehouses and data marts can be created, and databases can be de-normalized.

EIQ servers permit link analysis and mapping, which externally provides and maps links between, or groups, disparate data and information.

EIQ servers provide significant benefits compared to a federated database approach. Federated database systems are only as fast as the slowest data source. They are limited to the data indexed in individual systems and are sensitive to the way that the data is indexed. Additional queries load the system. Federated systems need a detailed understanding of the system, particularly indexes, resource requirements, etc. They will not necessarily allow multiple indexes on the same data and are limited to databases, excluding files, documents, email and other data types. Federated systems are unable to add external tables, data or information to the original data such that it is accessible through indexes. It may be difficult to use data and information from one data source to find data and information in another data source, preventing heuristic data mining across data sources. It may also be difficult to merge and work with result datasets, depending on metadictionaries and mapping.

EIQ servers have a number of technical features for indexing and query processing. Queries have extremely fast processing times in EIQ server systems. Query processing is executed virtually using indexes and Boolean operation on query result sets. As an example of complex query processing, one embodiment achieves sub-second responses to complex queries on a live one-billion record database.

EIQ servers work well with very large databases (VLDBs), handling a combination of high performance for complex queries by a large number of users on VLDBs. EIQ servers brings database technology benefits to other mainstream database technologies.

EIQ servers use real-time indexes with extremely fast update rates. These indexes allow insert, update and delete rates of up to tens of thousands of records per second on a single server. Queries can be made on the indexes immediately following the brief moment they are updated. One proof-of-concept achieved a single term query and insert rate of 80,000 records per second in a 60 gigabyte, 300 million record database on a dual-933 MHz Intel server with 4 gigabyte RAM and local SCSI, 7200 RPM RAID 5 disks.

EIQ servers permit a disproportionately high number of users per server. The high number of users per server are supported due to extremely fast index and query processing, virtual query processing, where data inn the database is not accessed until final result sets are isolated and user channel reuse, where channels or threads to the database engine are available to other users before and after a query execution.

Storage is required only for the indexes. Data remains in the source database. EIQ server indexes are very efficient and usually require substantially less space than conventional indexes. Storage can therefore be reduced overall if the EIQ server indexes replace some of the source database indexes.

Unique commands are provided to allow multiple way of presenting join data, and a heuristic select that performs link analysis and data mining functions that are traditionally dealt with through OLAP.

Immediate record counts are available at every point in a query. These counts are automatically tracked at the data value level and are also available in result-sets. The data itself does not need to be counted.

Embedded indexes are a separate form of indexes and can be used to accelerate access to low-level data by storing higher or same level data in low level indexes. Embedded indexes can be used to avoid or minimize extensive table-joins, compute aggregation statistics and aggregation data on the fly. For example, SUM AVERAGE, MAXIMUM, MINIMUM, MEAN, STD. DEVIATION, etc. They can also simplify complex queries. Embedded indexes and normal indexes can be combined for ad hoc aggregations that would not be possible with other database index and query technologies.

EIQ servers facilitate spatial and temporal queries. EIQ servers have exception range query processing. EIQ server indexes are well suited to processing range queries, such as GIS and period data, without creating interim or temporary tables. An oil and gas pre-processing utility is provided that cuts down by several orders of magnitude the time it takes to organize raw seismic data in particular, multi-component, 3D seismic data before processing and interpretation. This feature avoids the need to create OLAP-style PERIOD tables for subsequent analysis.

Listpick is a means of only retrieving data that is needed at a specific time using the indexes or result-set pointers. For instance, if a user queries and isolates millions of records from a VLDB, the entire millions of records do not need to be read and sent across a network to the user at one time, as this would take a long time, slow down the network and overwhelm the user. Instead, the user is only shown a limited number of records at any given time, e.g., 25, and is provided controls to navigate the list of data using pointers rather than actual data. This allows users to quickly page through huge numbers of records and jump to different points in the list of records without paging.

It will be appreciated by those skilled in the art having the benefit of this disclosure that this invention provides indexes with embedded data. It should be understood that the drawings and detailed description herein are to be regarded in an illustrative rather than a restrictive manner, and are not intended to limit the invention to the particular forms and examples disclosed. On the contrary, the invention includes any further modifications, changes, rearrangements, substitutions, alternatives, design choices, and embodiments apparent to those of ordinary skill in the art, without departing from the spirit and scope of this invention, as defined by the following claims. Thus, it is intended that the following claims be interpreted to embrace all such further modifications, changes, rearrangements, substitutions, alternatives, design choices, and embodiments.

1. A value field index for a database comprising:
a data index;
value field indexes embedded in said data index.

2. The value field index of claim 1, wherein said database is a relational database.

3. The value field index of claim 2, wherein said relational database is a high-normalized relational database.

4. A method for creating a value field index for data stored in a data source comprising the steps of:
analyzing a data source schema;
analyzing intended queries of the data;
analyzing the data;
identifying problematic queries;
designating token fields;
creating indexes using the data source schema; and
embedding the created indexes in other indexes.

5. The method of claim 4, further comprising the step of establishing update processes.

6. The method of claim 4, wherein said steps of analyzing are performed by automatic data profiling tools.

7. The method of claim 4, wherein problematic queries include multiple-table joins.

8. The method of claim 4, further comprising the step of using said value field index to denormalize a high-normalized relational database.

9. The method of claim 4, wherein said step of creating indexes is performed using a database technology of the data source.

10. The method of claim 4, wherein said step of creating indexes is performed using external indexing technology.

11. The method of claim 4, wherein the step of embedding indexes comprises storing the indexes as tokens.

12. The method of claim 4, wherein the step of embedding indexes comprises storing the indexes as part of indexes to other data.

13. The method of claim 12, wherein said indexes of other data are indexed.

14. The method of claim 5, wherein said step of establishing update processes include a batch mode.

15. The method of claim 5, wherein said step of establishing update processes include an incremental mode.

16. The method of claim 5, wherein said step of establishing update processes include a real-time mode.

17. A method of performing a spatial query of data in a data source at a spatial location X and Y using value indexes comprising the steps of:
querying the entities within specific X and Y ranges;
identifying bins for the X and Y ranges;
performing an X-range query using an X-range data index for the identified bins;
retrieving a data result set from the data source;
applying a Y range filter to the result set data to obtain spatial query results.
